(19) United States
(12) Patent Application Publication
(10) Pub. No.: US 2026/0005480 A1
(43) Pub. Date: Jan. 1, 2026

(54) ADAPTER FOR CABLE CONNECTION

(71) Applicant: Charter Communications Operating, LLC, St Louis, MO (US)

(72) Inventor: Richard M. Fletcher, JR., Aurora, CO (US)

(73) Assignee: Charter Communications Operating, LLC, St Louis, MO (US)

(21) Appl. No.: 18/758,788

(22) Filed: Jun. 28, 2024

(51) Int. Cl. H01R 24/54; H01R 103/00

(52) U.S. Cl. CPC H01R 24/542; H01R 24/545; H01R 2103/00

(57) ABSTRACT

A coaxial adapter that includes a housing defining a cavity therein, a male connector coupled to the housing, and a female connector at least partially disposed in the cavity of the housing. The female connector is configured to receive and secure a coaxial cable. The female connector includes an electrically conductive tube disposed in the housing and in electrical communication with the male connector. The electrically conductive tube is configured to electrically connect the coaxial cable and the male connector in a manner that eliminates signal loss and/or maintains a consistent impendence through a signal path of the coaxial adapter.

### TECHNICAL FIELD

This disclosure relates to adapters for cable connection, and more particularly, to adapters that provide an angled connection to a coaxial cable while minimizing signal loss.

### BACKGROUND

Coaxial cables are widely used for transmitting various electrical signals, such as television signals, internet data, other voice and radio signals, and other forms of radio frequency (RF) signals. Coaxial cables may typically include a center conductor, an insulating dielectric layer, a metallic shield, and an outer insulating layer. Such a structure may help with isolating the electrical signals with respect to interference and signal loss when transmitting the aforementioned electrical signals.

Given the wide range of applications that may utilize coaxial cables, the coaxial cables may often use various types of connectors and adapters to ensure proper connection between the coaxial cables and secondary devices (e.g., active and/or passive electronic devices, additional coaxial cables, etc.) In certain scenarios, conventional straight (i.e., linear) connectors and adapters may be problematic due to space constraints or other assembly constraints. As a result, other forms of connectors and adapters may be implemented, such as those with one or more bends to facilitate non-linear connection between the coaxial cable and the secondary devices.

### SUMMARY

In one implementation, a coaxial adapter is disclosed. The coaxial adapter includes a housing defining a cavity therein, a male connector coupled to the housing, and a female connector at least partially disposed in the cavity of the housing. The female connector is configured to receive and secure a coaxial cable. The female connector includes an electrically conductive tube disposed in the housing and in electrical communication with the male connector. The electrically conductive tube is configured to electrically connect the coaxial cable and the male connector.

In certain implementations, the male connector may project from a first surface of the housing away from the housing. Additionally, the female connector may be configured to receive and secure the coaxial cable such that the coaxial cable may be positioned substantially perpendicular to the male connector. The female connector may include a receiving portion that is defined by a second surface of the housing, whereby the receiving portion may be configured to receive the coaxial cable. The second surface of the housing may be substantially perpendicular to the first surface of the housing. Moreover, the receiving portion may permit access to the cavity of the housing and the coaxial cable may be configured for insertion into the receiving portion to engage the electrically conductive tube. The coaxial cable may be configured to mechanically engage the electrically conductive tube to electrically connect the coaxial cable and the male connector via the electrically conductive tube. Furthermore, the electrically conductive tube may include an engaging portion that is configured to engage a center conductor of the coaxial cable to couple the coaxial cable to the coaxial adapter. The engaging portion may be configured to engage the center conductor of the coaxial cable such that a pull-out force required to remove the center conductor from the electrically conductive tube is greater than an insertion force required to insert the center conductor into the electrically conductive tube.

In certain implementations, the electrically conductive tube may be configured to receive and secure a center conductor of the coaxial cable. The electrically conductive tube may be configured to receive only the center conductor of the coaxial cable therein.

In certain implementations, the electrically conductive tube may be at least partially surrounded by a dielectric material. The dielectric material may be contained within an electrically conductive shielding.

In another implementation, an adapter is disclosed. The adapter is configured to connect a coaxial cable with a secondary component. The adapter includes a housing, a male connector coupled to a first surface of the housing, and a female connector. The male connector includes a pin extending into the housing. The female connector includes a receiving portion configured to receive a portion of the coaxial cable and a tube disposed in the housing. The tube is configured to mechanically couple and electrically connect a center conductor of the coaxial cable to the pin of the male connector.

In certain implementations, a first portion of the pin and a second portion of the pin may form an angle of about 90 degrees, or a first portion of the tube and a second portion of the tube may form an angle of about 90 degrees. The first portion of the pin may be at least partially disposed in the housing and may extend out of the housing. The second portion of the pin may be inserted into the tube to electrically connect the center conductor of the coaxial cable to the pin. Additionally, the tube may be made of an electrically conductive material.

In certain implementations, a portion of the pin and the tube may be contained within a dielectric material that may be disposed in a cavity of the housing.

In certain implementations, the secondary component may be a secondary coaxial cable or an electronic device.

In another implementation, a coaxial adapter is disclosed. The coaxial adapter includes a housing defining a cavity therein, a male connector coupled to the housing, and a female connector. The male connector includes a projection located on a first surface of the housing external to the cavity of the housing and a pin extending through the projection and into the cavity of the housing. The female connector includes a receiving portion that is configured to receive a coaxial cable such that a portion of the coaxial cable is located within the cavity of the housing. The female connector also includes an electrically conductive tube disposed in the cavity of the housing and an engaging portion located within the electrically conductive tube. The electrically conductive tube is configured to receive a center conductor of the coaxial cable to electrically connect the center conductor to the pin. The electrically conductive tube includes a bend that is positioned within the cavity of the housing. Additionally, the engaging portion is configured to mechanically secure the center conductor of the coaxial cable within the electrically conductive tube.

In certain implementations, the bend of the electrically conductive tube may define an angle of about 90 degrees between a first portion of the electrically conductive tube and a second portion of the electrically conductive tube.

In certain implementations, a portion of the pin may extend through a dielectric material located within the housing and into the electrically conductive tube.

In certain implementations, the pin may be mechanically coupled to the electrically conductive tube.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a perspective view of an adapter in accordance with the present disclosure.

FIG. 2 is a front view of the adapter of FIG. 1.

FIG. 3A is a cross-sectional view of the adapter shown in FIG. 2 prior to connection of a coaxial cable to the adapter.

FIG. 3B is the cross-sectional view shown in FIG. 3A after connection of a coaxial cable to the adapter.

FIG. 4 is a second example of a cross-sectional view of an adapter in accordance with the present disclosure.

FIG. 5 is a third example of a cross-sectional view of an adapter in accordance with the present disclosure.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers—a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is an adapter that is configured to connect a cable to a secondary device and/or a secondary cable. The adapter may be configured to connect one or more coaxial cables to the secondary device and/or the secondary cable (e.g., an additional coaxial cable). To facilitate such connection, the adapter may include one or more connectors (e.g., connecting portions) that may connect to the coaxial cable and the secondary device or secondary cable. Similarly, the one or more connectors (e.g., connecting portions) of the adapter may also connect directly to another connector, which may be coupled to a coaxial cable or may be free of connection to a coaxial cable. That is, in certain configurations, the adapter may be configured to connect to a connector rather than a bare coaxial cable (e.g., a coaxial cable free of a connector). As such the adapter may act as a coaxial connector to facilitate connection of the coaxial cable to the secondary device and/or the secondary cable and may also act as an adapter to facilitate different types of connection interfaces. While coaxial cables are referenced herein, it is envisioned that the adapter described herein may be configured for various other types of cables.

In certain situations, space constraints may pose a significant challenge for connecting a coaxial cable to a secondary device or a secondary coaxial cable. For example, space constraints may prevent the coaxial cable from connecting to the secondary device or the secondary coaxial cable in a linear manner. In such a case, a conventional straight connector may not properly fit within the confined space. Use of the straight connector may thus result in potential strain and/or kinking of the coaxial cable and/or the secondary device or secondary coaxial cable, which may result in degraded signal quality, physical degradation (e.g., damage) to the coaxial cable and/or the secondary device or secondary coaxial cable, or both.

To address the above spatial limitations, a conventional right-angle adapter may be employed to facilitate a 90-degree connection between the coaxial cable and the secondary device or the secondary coaxial cable. However, conventional right-angle adapters may frequently result in increased signal loss or fluctuation in impendence through the adapter due to the abrupt change in direction of the signal path through the conventional right-angle adapter. For example, conventional right-angle adapters may often implement a set screw to secure the coaxial cable to the conventional right-angle adapter. However, due to the 90-degree bend in the adapter, the signal transmitted through the coaxial cable may be unable to travel through the 90-degree bend and instead reflect off of the set screw or shielding within the conventional right-angle adapter. As a result, signal loss and fluctuations in impendence may occur, especially in applications where a higher frequency signal is transmitted (e.g., 1.8 GHz or higher).

The adapter described herein addresses the above problems. In particular, the adapter described herein may establish a right-angled connection between a coaxial cable and a secondary device or secondary cable. The right-angle connection established by the adapter may substantially minimize or even eliminate signal loss caused by the signal path (e.g., the 90-degree signal path) within the adapter. The right-angle connection established by the adapter may also maintain a consistent impendence through the signal path of the adapter to substantially minimize or even eliminate impendence fluctuation within the adapter. Moreover, coupling (e.g., connection) of the coaxial cable to the adapter may be done quickly and easily to improve the overall ease of use of the adapter.

By way of example, the adapter may be configured to support higher frequency transmission of a signal between the coaxial cable and the secondary device. In the context of this example, higher frequency transmission may be considered a frequency of about 1 GHz or higher (e.g., about 2 GHz). While a conventional right-angle adapter may be unable to transfer the higher frequency signal without significant signal loss or impendence fluctuation, the adapter herein may maintain a consistent impendence and substantially minimize or eliminate signal loss. As such, the adapter described herein may provide packaging solutions for constrained spaces without negatively impacting the signal quality transferred.

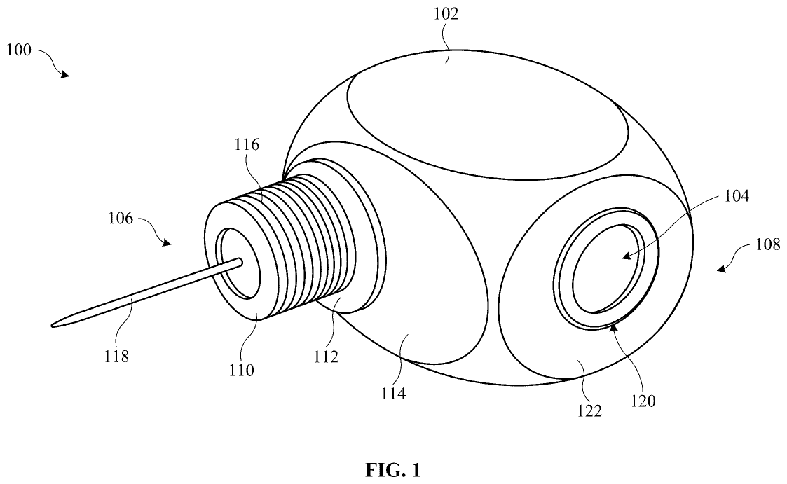

Turning now to the figures, FIG. 1 illustrates a perspective view of an adapter 100 in accordance with the present teachings. The adapter 100 may be configured for use with a coaxial cable. Thus, the adapter 100 may be considered and referred to herein as a coaxial adapter.

As shown in FIG. 1, the adapter 100 may include a housing 102. The housing 102 may be any size and/or shape and is not limited to any particular geometry. The housing 102 may form an overall body of the adapter 100. The housing 102 may also contain one or more portions or components of the adapter 100. For example, the housing 102 may define a cavity 104 therein, whereby connection between a coaxial cable and a secondary component or secondary coaxial cable may be completed within the cavity 104 of the housing 102. Such connection may be an electrical connection (e.g., to facilitate signal transmission through the coaxial cable to the secondary component or secondary coaxial cable and/or from the secondary component or secondary coaxial cable to the coaxial cable), a mechanical connection, or both. That is, the housing 102 may provide an electrical and/or mechanical connection between the coaxial cable and the secondary component or secondary coaxial cable. The housing 102 may also provide an electrical and/or mechanical connection between a connector of a coaxial cable and the secondary component or secondary coaxial cable. Thus, while coaxial cables may be referenced herein with respect to direct connection to the adapter 100, coaxial cable connectors may also be connected to the adapter 100 in a similar manner unless otherwise stated.

It should also be noted that while connection between the coaxial cable and one secondary component or secondary coaxial cable is discussed in detail herein, the adapter 100 may also be configured to connect the coaxial cable to more than one component or additional coaxial cable. For example, the adapter 100 may connect the coaxial cable to a pair of secondary components or a pair of secondary coaxial cable. Thus, the adapter 100 may act as a junction therebetween.

To facilitate connection between the coaxial cable and the secondary component or secondary coaxial cable, the housing 102 may include a male connector 106 and a female connector 108. The male connector 106 may be configured to couple the adapter 100 to the secondary component or secondary coaxial cable. It should be noted that the secondary component may be any passive or active electronic device, such as an amplifier, computer, router, modem, television, other electronic device, or a combination thereof. For simplicity, as discussed below, secondary component may be inclusive of a secondary coaxial cable.

The female connector 108 may be configured to couple the coaxial cable to the adapter 100. Thus, the coaxial cable may be connected to the adapter 100 via the female connector 108 and the secondary component may be connected to the adapter 100 via the male connector 106, thereby connecting the secondary component to the coaxial cable via the adapter 100. To illustrate such connection, the male connector 106 and the female connector 108 will be described in further detail below.

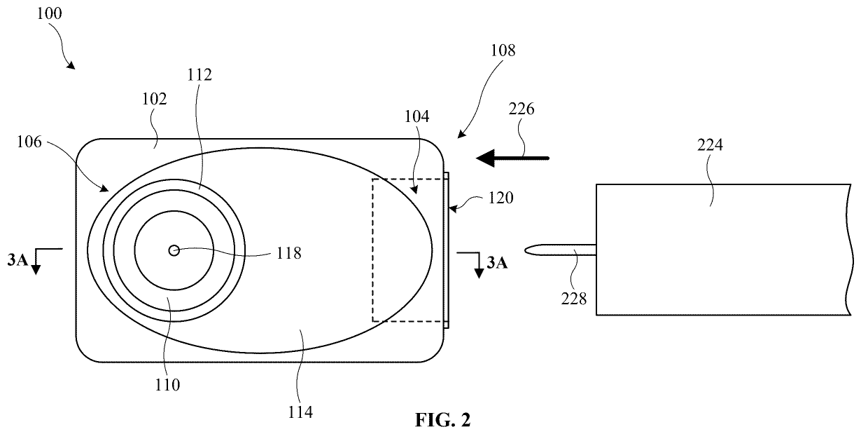

The male connector 106 may be coupled to the housing 102 and may be located external to the housing 102, internally within the housing 102 (e.g., within the cavity 104 of the housing 102) or both. For example, the male connector 106 may include a projection 110 that extends from (e.g., projects from) a base 112 of the projection 110 away from the housing 102. The projection 110 of the male connector 106 may be positioned anywhere along the housing 102. For example, as shown in FIG. 2, the projection 110 may be disposed on a first surface 114 and extend outward away from the housing 102. That is, the first surface 114 may be an outer surface of the housing 102, and the projection 110 may extend away from the first surface 114 of the housing 102.

The male connector 106 may be configured to both mechanically and electrically connect the secondary component to the adapter 100. For example, to mechanically connect the secondary component to the adapter 100, the projection 110 may include threading 116 that may engage threading of the secondary component. However, any mechanical interlock or connection may be possible between the male connector 106 and the secondary component. Additionally, to electrically connect the secondary component to the adapter 100, the male connector 106 may also include a pin 118. The pin 118 may be positioned within the projection 110 and protrude from the projection 110 such that the pin 118 may be received by the secondary component (e.g., within a female connector of the secondary component), thereby electrically connecting the secondary component to the adapter 100. Moreover, as described in further detail below, the pin 118 may also extend into the housing 102 (e.g., into the cavity 104 of the housing 102) such that the pin 118 also facilitate electrical connection with the coaxial cable through the adapter 100.

The female connector 108 may be at least partially disposed in the cavity 104 of the housing 102. The female connector 108 may be configured to receive and secure the coaxial cable to mechanically and/or electrically connect the coaxial cable to the adapter 100 and thus also to the secondary component. For example, the female connector 108 may include a receiving portion 120 that may be defined by a surface of the housing 102 other than the first surface 114, such as a second surface 122 of the housing 102. The receiving portion 120 may be an opening, hole, channel, cutout, or similar feature that may receive the coaxial cable such that a portion of the coaxial cable may be inserted into the cavity 104 of the housing 102. However, the receiving portion 120 may be any size and/or shape that may allow insertion of the coaxial cable into the adapter 100. That is, the receiving portion 120 may be any feature that permits access to the cavity 104 of the housing 102.

The adapter 100 may provide a right-angle connection between the coaxial cable and the secondary component. That is, the female connector 108 may receive and secure the coaxial cable (e.g., via the receiving portion 120) such that the coaxial cable is positioned substantially perpendicular to the male connector 106. As a result, the coaxial cable and the male connector 106 may form an angle of about 90-degrees. For example, the second surface 122 of the housing 102 may be substantially perpendicular to the first surface 114 of the housing 102 to define the about 90-degree angle between the male connector 106 and the coaxial cable inserted into the female connector 108.

However, any angle may be formed between the male connector 106 and the coaxial cable. For example, in certain configurations, the adapter 100 may be configured to provide a connection between the coaxial cable and the male connector 106 such that the coaxial cable and the male connector 106 form an angle of about 30 degrees or more, an angle of about 45 degrees or more, or an angle of about 60 degrees or more. The adapter 100 may be configured to provide a connection between the coaxial cable and the male connector 106 such that the coaxial cable and the male connector 106 form an angle of about 150 degrees or less, about 135 degrees or less, or about 120 degrees or less. Thus, it may be gleaned from the present teachings that any positioning of the coaxial cable relative to the male connector 106 may be possible.

FIG. 2 illustrates a front view of the adapter 100 shown in FIG. 1. As described above, the adapter 100 may be configured to connect a coaxial cable, such as the coaxial cable 224 to the secondary component. The coaxial cable 224 may be inserted into the female connector 108 such that a portion of the coaxial cable 224 may be positioned within the cavity 104 defined by the housing 102, as illustrated by the dashed line shown in FIG. 2. It should be noted that the dashed line is intended for illustrative purposes only, and the cavity 104 of the housing 102 may be any size and/or shape.

To further illustrate connection of the coaxial cable 224 to the adapter 100, a method of installation will now be described. To secure the coaxial cable 224 to the adapter 100, the coaxial cable 224 may be inserted into, and positioned within, the cavity 104 of the housing 102 through the receiving portion 120. The coaxial cable 224 may be inserted into the receiving portion 120 of the female connector 108 in a direction 226 such that a portion of the coaxial cable 224 (e.g., an end portion of the coaxial cable 224) is located in the cavity 104 of the housing 102.

The coaxial cable 224 may include a center conductor 228 that is configured to transmit the electrical signal through the coaxial cable 224. As such, a portion of the coaxial cable 224 may be inserted into the cavity 104 through the receiving portion 120 of the female connector 108 such that the center conductor 228 may be in electrical communication with the pin 118 of the male connector 106. As discussed further below, the female connector 108 may be configured to mechanically engage the center conductor 228 of the coaxial cable 224 such that a pull-out force (e.g., in a direction opposing the direction 226) required to remove the center conductor 228 from the female connector 108 is greater than insertion force (e.g., in the direction 226) required to insert the center conductor into the female connector 108.

Once the coaxial cable 224 is inserted into the cavity 104 to mechanically and electrically couple the coaxial cable 224 to the adapter 100, the adapter 100 may be coupled to the secondary component using the male connector 106. For example, a female connector of the secondary component may be threaded onto the projection 110 such that the pin 118 of the male connector 106 may be received by the secondary component, thereby established electrical connection between the secondary component and the adapter 100, and thus also between the secondary component and the coaxial cable 224.

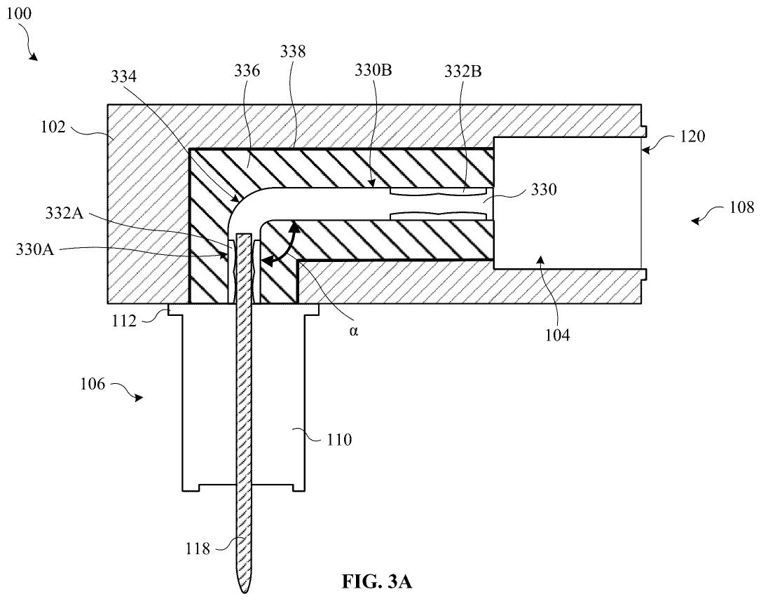

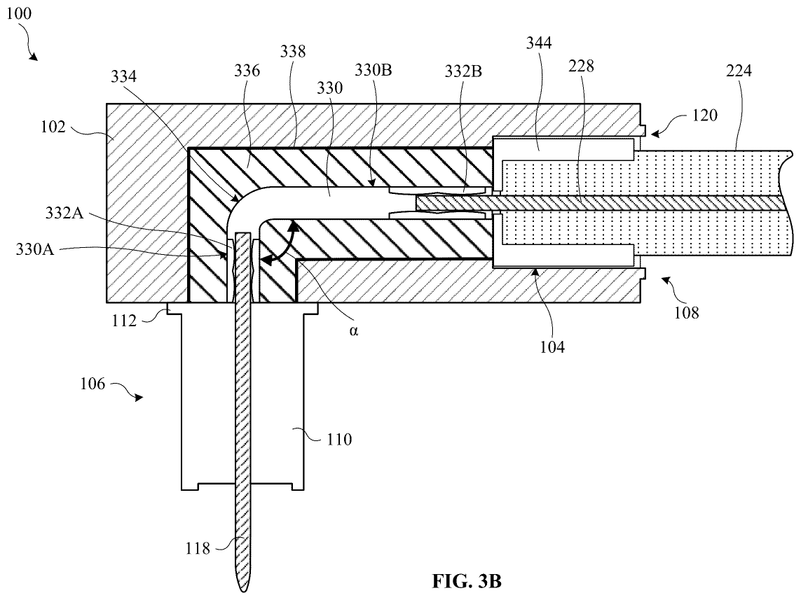

FIG. 3A illustrates cross-section 3A-3A of the adapter 100 shown in FIG. 2 prior to connection of the coaxial cable 224 to the adapter 100. FIG. 3B illustrates cross-section 3A-3A of the adapter 100 shown in FIG. 2 after connection of the coaxial cable 224 to the adapter 100.

As discussed above, the adapter 100 may include the housing 102 that defines the cavity 104 therein. The adapter 100 may also include the male connector 106, which may be coupled to the housing 102 and configured to couple the adapter 100 to a secondary component. Additionally, the adapter 100 may include the female connector 108, which may be configured to receive and secure the coaxial cable 224 therein. As discussed above with respect to FIG. 2, the coaxial cable 224 may be inserted into the receiving portion 120 of the female connector 108 so that a portion of the coaxial cable 224, including a portion of the center conductor 228 of the coaxial cable 224, may be positioned within the cavity 104 of the housing 102. As a result, the coaxial cable 224 may be mechanically and electrically coupled to the adapter 100 and thus also mechanically and electrically coupled to the secondary component connected to the male connector 106 of the adapter 100.

To facilitate connection of the coaxial cable 224, the female connector 108 may include a tube 330. The tube 330 may be disposed in the housing 102, such as within the cavity 104 of the housing 102, and may be configured to receive a portion of the coaxial cable 224 to secure the coaxial cable 224 to the adapter 100. That is, the receiving portion 120 of the female connector 108 may permit access to the cavity 104 of the housing 102 and the coaxial cable 224 may be inserted into the receiving portion 120 to engage the tube 330, thereby connecting the coaxial cable 224 to the adapter 100.

Additionally, it should be noted that one or more portions of the female connector 108 other than the tube 330 may also engage the coaxial cable 224 to secure the coaxial cable 224 therein. For example, as shown in FIG. 3B, the coaxial cable 224 may include or may be part of a connector 344. The connector 344 may engage an internal surface of the female connector 108 such that the connector 344 may be coupled to and within the female connector 108. For example, the connector 344 may include external threading which may engage internal threated of the female connector 108. As such, it should be noted that the adapter 100 may be configured to removably couple to a coaxial cable 224 that includes a connector similar to the connector 344, may be configured to removably couple to a connector similar to the connector 344 free of the coaxial cable 224 (e.g., the adapter 100 may be coupled to a connector, whereby the connector does not include and/or is not coupled to a coaxial cable), may be configured to removably couple to the coaxial cable 224 free of the connector, or a combination thereof.

The tube 330 may be configured to directly or indirectly mechanically couple the center conductor 228 of the coaxial cable 224 to the pin 118 of the male connector 106. For example, as shown in FIGS. 3A and 3B, the tube 330 may include a first portion 330A and a second portion 330B. The pin 118 may extend through the projection 110 of the male connector 106 and into the housing 102 (e.g., into the cavity 104 of the housing 102) such that the pin 118 may be coupled to the first portion 330A of the tube 330. Similarly, the coaxial cable 224 may be inserted into the cavity 104 of the housing 102 through the receiving portion 120 of the female connector 108 such that the center conductor 228 of the coaxial cable 224 is received by the tube 330. As a result, the pin 118 and the center conductor 228 of the coaxial cable 224 may be coupled to one another via the tube 330.

The tube 330 may include any features, components, shapes, or the like that may facilitate mechanical coupling of the center conductor 228 of the coaxial cable 224 and the pin 118 to the tube 330. By way of example, the tube 330 may include a first engaging portion 332A located within the tube 330 and a second engaging portion 332B located within the tube 330. The first engaging portion 332A may be disposed in the first portion 330A of the tube 330 and the second engaging portion 332B may be disposed in the second portion 330B of the tube 330. As a result, the first engaging portion 332A may be configured to receive and mechanically secure the pin 118 within the first portion 330A of the tube 330 and the second engaging portion 332B may be configured to receive and mechanically secure the center conductor 228 of the coaxial cable 224 within the second portion 330B of the tube 330.

The first engaging portion 332A and the second engaging portion 332B may be similar to one another or may be dissimilar. The first engaging portion 332A and the second engaging portion 332B may be any mechanical feature that may facilitate coupling of the center conductor 228 and the pin 118 to the tube 330 and within the tube 330. That is, the first engaging portion 332A and the second engaging portion 332B may be disposed in the tube 330 and configured to engage the pin 118 and the center conductor 228, respectively, to couple the pin 118 and the center conductor 228 to the tube 330 and prevent unwanted disconnect of the pin 118 and/or the center conductor 228 from the tube 330. For example, the second engaging portion 332B may be configured to receive only the center conductor 228 of the coaxial cable 224 therein to secure the coaxial cable 224 to the adapter 100.

The first engaging portion 332A and the second engaging portion 332B may be a portion of the tube 330 that may receive the pin 118 and the center conductor 228, respectively. The first engaging portion 332A and the second engaging portion 332B may be a sleeve or other retaining feature that may receive the pin 118 or the center conductor 228 yet prevent removal of the pin 118 or the center conductor 228. For example, the second engaging portion 332B may be configured to engage the center conductor 228 of the coaxial cable 224 such that a pull-out force required to remove the center conductor 228 from the tube 330 is greater than an insertion force required to insert the center conductor 228 into the tube 330. A similar engagement with the pin 118 may also be facilitated by the first engaging portion 332A.

It should be noted that the tube 330 may in some configurations be free of the first engaging portion 332A. For example, the pin 118 may be integrally formed with, or otherwise coupled to, the tube 330 such that the first engaging portion 332A may not be necessary. For example, the tube 330 may be soldered or otherwise formed with an end of the pin 118 that is located within the cavity 104 of the housing 102. As a result, permanent connection may exist between the pin 118 and the tube 330.

The tube 330 may be configured to both mechanically couple and electrically connect the center conductor 228 of the coaxial cable 224 to the pin 118 of the male connector 106. Mechanical coupling of the center conductor 228 and the pin 118 may be facilitated by the first engaging portion 332A and the second engaging portion 332B of the tube 330. Electrical connection between the center conductor 228 and the pin 118 may be facilitated by electrical conductivity of the tube 330. While the tube 330 is not limited to any particular material, the tube 330 may be made of an electrically conductive material (e.g., the tube 330 is an electrically conductive tube) such that the electrical signal transmitted through the center conductor 228 of the coaxial cable 224 may pass through the tube 330 and into the pin 118. As such, physical contact (e.g., mechanical engagement) between the pin 118 and the tube 330 and the center conductor 228 and the tube 330 may allow for electrical communication between the pin 118 and the center conductor 228, thus facilitating electrical connection between coaxial cable 224 and the male connector 106.

As discussed above, the adapter 100 may facilitate connection of the coaxial cable 224 (or a connector of the coaxial cable 224) to a secondary component at a right angle with minimal or no signal loss and/or with minimal or no impendence variation. To facilitate such positioning without an impact to the signal quality, the tube 330 may include a bend 334 therein. The bend 334 may be positioned within the cavity 104 of the housing 102. The bend 334 of the tube 330 may define an angle (a) of about 90 degrees between the first portion 330A of the tube 330 and the second portion 330B of the tube 330. That is, the first portion 330A of the tube 330 and the second portion 330B of the tube 330 may form an angle (a) of about 90 degrees so that the coaxial cable 224 is located substantially orthogonal to the male connector 106. However, as discussed above, the angle (a) may be any desired angle and may be defined by a shape (e.g., radius) of the bend 334 in the tube 330.

To further maintain signal quality (e.g., signal strength, signal impendence, etc.), the tube 330 may be at least partially surrounded by a dielectric material 336. The dielectric material may be any insulating material that does not conduct electric current but may support the formation of an electric field. For example, the dielectric material 336 may be disposed in the cavity 104 of the housing 102 around the tube 330 to space the tube 330 apart from a shielding 338 located within the cavity 104 of the housing 102, thereby decreasing or even preventing signal loss and/or signal interference caused by interaction with the shielding 338. Alternatively, or additionally, an air dielectric may be also be implemented in the adapter 100. As shown in FIGS. 3A and 3B, the dielectric material 336 may be contained within the shielding 338, whereby the shielding 338 may be made of an electrically conductive material.

Based on such positioning of the tube 330 and the dielectric material 336, the tube 330 may function as a waveguide to direct the electrical signal and bend the electrical signal through the adapter 100 such that the direction of the electrical signal travels through the right-angled shape of the tube 330. Integrity of the electrical signal may be maintained based upon the structure of the tube 330 and positioning of the dielectric material 336 around the tube 330. For example, the dielectric material 336 may maintain an equal distance between the tube 330 and the shielding 338 and/or between the tube 330 and an outer surface of housing 102. It should also be noted that in addition to, or in lieu of, the dielectric material 336, certain configurations of the adapter 100 may also establish an air gap between the tube 330 and the shielding 338 and/or between the tube 330 and the outer surface of the housing 102 to maintain signal integrity.

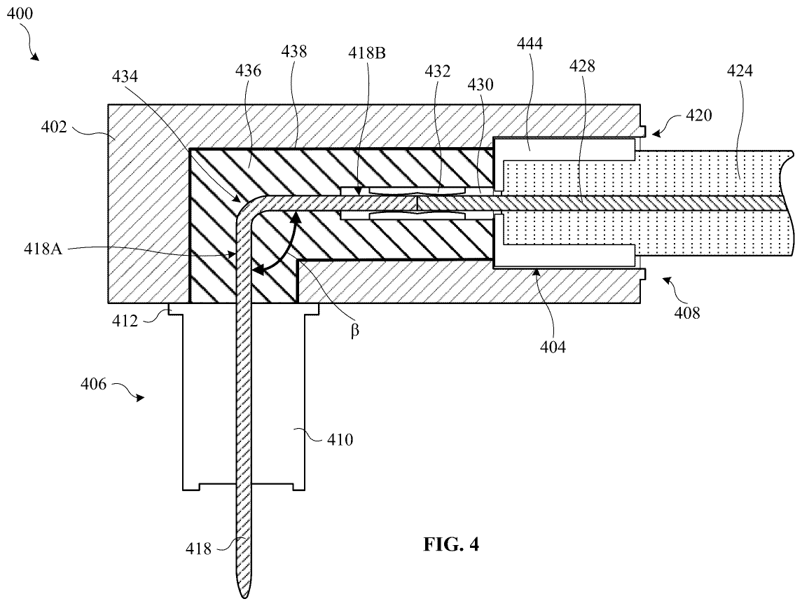

FIG. 4 illustrates a cross-sectional view of a second example of an adapter 400. The adapter 400 may be similar to the adapter 100 described above with respect to FIGS. 1-3B. For example, the adapter 400 may be configured to couple a coaxial cable, such as the coaxial cable 424, to a secondary component.

The adapter 400 may include a housing 402 that defines a cavity 404 therein. The adapter 400 may also include a male connector 406 and a female connector 408. The male connector 406 may be similar to the male connector 106 of the adapter 100 and may be configured to couple a secondary component to the adapter 400. For example, the male connector 406 may include a projection 410 that extends away from the adapter 400, whereby the projection 410 may be coupled to an outer surface of the housing 402 via a base 412 located therebetween. The male connector 406 may also include a pin 418 extending through the projection 410 and into the cavity 404 of the housing 402.

The female connector 408 may be similar to the female connector 108 of the adapter 100 and may be configured to secure the coaxial cable 424 and/or a connector 444 of the coaxial cable 424 to the adapter 400. For example, the female connector 408 may include a receiving portion 420 that receives a portion of the coaxial cable 424 and/or the connector 444 such that a center conductor 428 of the coaxial cable 424 may be received be a tube 430 disposed in the cavity 404 of the housing 402. The connector 444 may be threaded or otherwise engaged to an inner surface of the female connector 408.

Similar to the tube 330 of the adapter 100, the tube 430 may be thermally conductive and may be configured to both mechanically and electrically couple the center conductor 428 of the coaxial cable 424 to the pin 418 of the male connector 406, thereby mechanically and electrically coupling the coaxial cable 424 to the secondary component. While the adapter 100 shown in FIGS. 3A and 3B illustrates that the tube 330 may include the bend 334 to extend between the pin 118 and the center conductor 128, the tube 430 may be substantially linear and may receive and secure both the center conductor 428 of the coaxial cable 424 and the pin 418 via an engaging portion 432 disposed in the tube 430. The engaging portion 432 may be similar to the first engaging portion 332A and the second engaging portion 332B of the adapter 100 described above. That is, the engaging portion 432 may be configured to mechanically couple the pin 418 and/or the center conductor 428 to the tube 430. It should be noted that in certain configurations, the tube 330 may be integrally formed or coupled to the pin 418 such that the pin 418 is not coupled to the tube 430 via the engaging portion 432.

To facilitate communication and/or engagement between the pin 418 and the center conductor 428 of the coaxial cable 424 via the tube 430 therebetween, the pin 418 may include a first portion 418A and a second portion 418B connected to one another via a bend 434 of the pin 418. The first portion 418A of the pin 418 may be at least partially disposed in the housing 402 (e.g., in the cavity 404 of the housing 402) and may extend out of the housing 402 to communicate with the secondary component. The second portion 418B of the pin 418 may be inserted into the tube 430 to electrically connect the center conductor 428 of the coaxial cable 424 to the pin 418. As shown in FIG. 4, the first portion 418A of the pin 418 and the second portion 418B of the pin 418 may form an angle (β) of about 90 degrees therebetween to facilitate a right-angle connection between the coaxial cable 424 and the secondary component. However, any angle between the first portion 418A of the pin 418 and the second portion 418B of the pin 418 may be defined by the bend 434 therebetween.

Additionally, to prevent signal loss and/or other signal interference, the pin 418 (e.g., the first portion 418A of the pin 418 and/or the second portion 418B of the pin 418) and the tube 430 may be positioned within and extend through a dielectric material 436 that is located within the housing 402. For example, the first portion 418A of the pin 418, the bend 434, and the second portion 418B of the pin 418 may extend through the dielectric material 436 within the housing 402 such that the second portion 418B of the pin 418 may extend into the tube 430. As such, the pin 418 and the tube 430 may be spaced apart from a shielding 438 located within the housing 402 by the dielectric material 436.

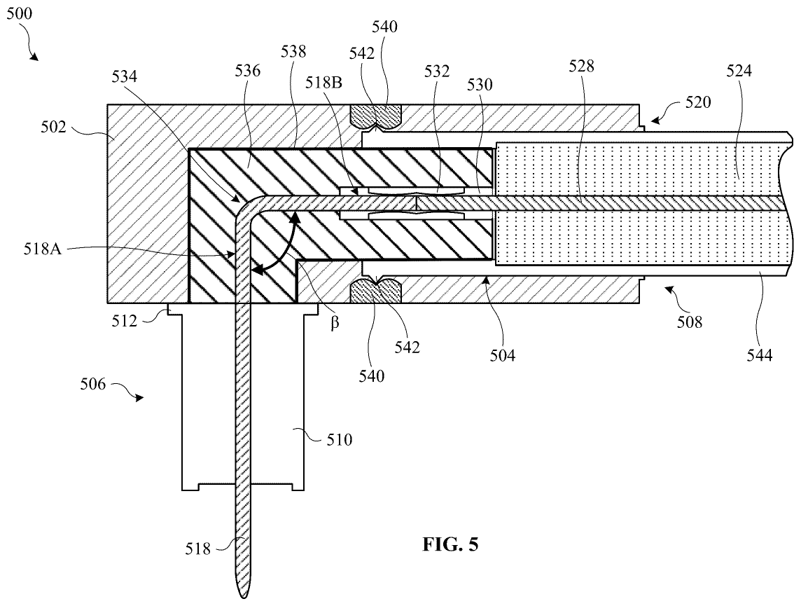

FIG. 5 illustrates a cross-sectional view of a third example of an adapter 500. The adapter 500 may be similar to the adapter 100 and the adapter 400 described above. For example, the adapter 500 may be configured to couple a coaxial cable, such as the coaxial cable 524, to a secondary component.

The adapter 500 may include a housing 502 that defines a cavity 504 therein. The adapter 500 may also include a male connector 506 and a female connector 508. The male connector 506 may be similar to the male connector 106 of the adapter 100 and may be configured to couple a secondary component to the adapter 500. For example, the male connector 506 may include a projection 510 that extends away from the adapter 500, whereby the projection 510 may be coupled to an outer surface of the housing 502 via a base 512 located therebetween. The male connector 506 may also include a pin 518 extending through the projection 510 and into the cavity 504 of the housing 502.

The female connector 508 may be similar to the female connector 108 of the adapter 100 and may be configured to secure the coaxial cable 524 to the adapter 500. For example, the female connector 508 may include a receiving portion 520 that receives a portion of the coaxial cable 524 such that a center conductor 528 of the coaxial cable 524 may be received by a tube 530 disposed in the cavity 504 of the housing 502. The female connector 508 may also include one or more locking portions 540 that may be configured to further engage the coaxial cable 524 to secure the coaxial cable 524 within the cavity 504 of the housing 502. For example, the locking portions 540 may engage teeth 542 of a connector 544 of the coaxial cable 524 such that the connector 544 of the coaxial cable 524 is also located and secured within the cavity 504 of the housing 502.

Similar to the tube 330 of the adapter 100, the tube 530 may be thermally conductive and may be configured to both mechanically and electrically couple the center conductor 528 of the coaxial cable 524 to the pin 518 of the male connector 506, thereby mechanically and electrically coupling the coaxial cable 524 to the secondary component. While the adapter 100 shown in FIGS. 3A and 3B illustrates that the tube 330 may include the bend 334 to extend between the pin 118 and the center conductor 128, the tube 530 may be substantially linear and may receive and secure both the center conductor 528 of the coaxial cable 524 and the pin 518 via an engaging portion 532 disposed in the tube 530. The engaging portion 532 may be similar to the first engaging portion 332A and the second engaging portion 332B of the adapter 100 described above. That is, the engaging portion 532 may be configured to mechanically couple the pin 518 and/or the center conductor 528 to the tube 530. It should be noted that in certain configurations, the tube 530 may be integrally formed or coupled to the pin 518 such that the pin 518 is not coupled to the tube 530 via the engaging portion 532.

To facilitate communication and/or engagement between the pin 518 and the center conductor 528 of the coaxial cable 524 via the tube 530 therebetween, the pin 518 may include a first portion 518A and a second portion 518B connected to one another via a bend 534 of the pin 518. The first portion 518A of the pin 518 may be at least partially disposed in the housing 502 (e.g., in the cavity 504 of the housing 502) and may extend out of the housing 502 to communicate with the secondary component. The second portion 518B of the pin 518 may be inserted into the tube 530 to electrically connect the center conductor 528 of the coaxial cable 524 to the pin 518. As shown in FIG. 5, the first portion 518A of the pin 518 and the second portion 518B of the pin 518 may form an angle (0) of about 90 degrees therebetween to facilitate a right-angle connection between the coaxial cable 524 and the secondary component. However, any angle between the first portion 518A of the pin 518 and the second portion 518B of the pin 518 may be defined by the bend 534 therebetween.

Additionally, to prevent signal loss and/or other signal interference, the pin 518 (e.g., the first portion 518A of the pin 418 and/or the second portion 518B of the pin 418) and the tube 530 may be positioned within and extend through a dielectric material 536 that is located within the housing 502. For example, the first portion 518A of the pin 518, the bend 534, and the second portion 518B of the pin 518 may extend through the dielectric material 536 within the housing 502 such that the second portion 518B of the pin 518 may extend into the tube 530. As such, the pin 518 and the tube 530 may be spaced apart from a shielding 538 located within the housing 502 by the dielectric material 536.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A coaxial adapter, comprising:
a housing defining a cavity therein;
a male connector coupled to the housing; and
a female connector at least partially disposed in the cavity of the housing and configured to receive and secure a coaxial cable, wherein the female connector includes:
an electrically conductive tube disposed in the housing and in electrical communication with the male connector, wherein the electrically conductive tube is configured to electrically connect the coaxial cable and the male connector.

2. The coaxial adapter of claim 1, wherein the male connector projects from a first surface of the housing away from the housing and the female connector is configured to receive and secure the coaxial cable such that the coaxial cable is positioned substantially perpendicular to the male connector.

3. The coaxial adapter of claim 2, wherein the female connector includes a receiving portion that is defined by a second surface of the housing, and the receiving portion is configured to receive the coaxial cable.

4. The coaxial adapter of claim 3, wherein the second surface of the housing is substantially perpendicular to the first surface of the housing.

5. The coaxial adapter of claim 3, wherein the receiving portion permits access to the cavity of the housing and the coaxial cable is configured for insertion into the receiving portion to engage the electrically conductive tube.

6. The coaxial adapter of claim 5, wherein the coaxial cable is configured to mechanically engage the electrically conductive tube to electrically connect the coaxial cable and the male connector via the electrically conductive tube.

7. The coaxial adapter of claim 6, wherein the electrically conductive tube includes an engaging portion that is configured to engage a center conductor of the coaxial cable to couple the coaxial cable to the coaxial adapter.

8. The coaxial adapter of claim 7, wherein the engaging portion is configured to engage the center conductor of the coaxial cable such that a pull-out force required to remove the center conductor from the electrically conductive tube is greater than an insertion force required to insert the center conductor into the electrically conductive tube.

9. The coaxial adapter of claim 1, wherein the electrically conductive tube is configured to receive and secure a center conductor of the coaxial cable, and the electrically conductive tube is configured to receive only the center conductor of the coaxial cable therein.

10. The coaxial adapter of claim 1, wherein the electrically conductive tube is at least partially surrounded by a dielectric material, and the dielectric material is contained within an electrically conductive shielding.

11. An adapter configured to connect a coaxial cable with a secondary component, comprising:
a housing;
a male connector coupled to a first surface of the housing and that includes a pin extending into the housing; and
a female connector that includes:
a receiving portion configured to receive a portion of the coaxial cable; and
a tube disposed in the housing, wherein the tube is configured to mechanically couple and electrically connect a center conductor of the coaxial cable to the pin of the male connector.

12. The adapter of claim 11, wherein a first portion of the pin and a second portion of the pin form an angle of about 90 degrees or a first portion of the tube and a second portion of the tube form an angle of about 90 degrees.

13. The adapter of claim 12, wherein the first portion of the pin is at least partially disposed in the housing and extends out of the housing, and the second portion of the pin is inserted into the tube to electrically connect the center conductor of the coaxial cable to the pin.

14. The adapter of claim 13, wherein the tube is made of an electrically conductive material.

15. The adapter of claim 11, wherein a portion of the pin and the tube are contained within a dielectric material that is disposed in a cavity of the housing.

16. The adapter of claim 11, wherein the secondary component is a secondary coaxial cable or an electronic device.

17. A coaxial adapter, comprising:
a housing defining a cavity therein;
a male connector coupled to the housing and that includes:
a projection located on a first surface of the housing external to the cavity of the housing; and
a pin extending through the projection and into the cavity of the housing; and
a female connector that includes:
a receiving portion that is configured to receive a coaxial cable such that a portion of the coaxial cable is located within the cavity of the housing;
an electrically conductive tube disposed in the cavity of the housing, wherein the electrically conductive tube is configured to receive a center conductor of the coaxial cable to electrically connect the center conductor to the pin, and the electrically conductive tube includes a bend that is positioned within the cavity of the housing; and
an engaging portion located within the electrically conductive tube, wherein the engaging portion is configured to mechanically secure the center conductor of the coaxial cable within the electrically conductive tube.

18. The coaxial adapter of claim 17, wherein the bend of the electrically conductive tube defines an angle of about 90 degrees between a first portion of the electrically conductive tube and a second portion of the electrically conductive tube.

19. The coaxial adapter of claim 17, wherein a portion of the pin extends through a dielectric material located within the housing and into the electrically conductive tube.

20. The coaxial adapter of claim 17, wherein the pin is mechanically coupled to the electrically conductive tube.
